(19) United States
(12) Patent Application Publication
(10) Pub. No.: US 2009/0226870 A1
(43) Pub. Date: Sep. 10, 2009

(54) Method and system for interactive learning

(76) Inventor: Jody M. Minotti, Bloomfield, CT (US)

Correspondence Address: Robert L. Rispoli;Clayman, Tapper & Baram, LLC, 3 Regency Drive, Bloomfield, CT, 06002, US

(21) Appl. No.: 12/322,469

(22) Filed: Feb. 3, 2009

Related U.S. Application Data
(60) Provisional application No. 61/065,068, filed on Feb. 8, 2008.

(51) Int. Cl. G09B 25/00; G09B 5/00

(52) U.S. Cl. 434/322; 434/307 R

(57) ABSTRACT

A method and system for interactive learning provides help for a user to improve their overall academic skill and automatic processing ability, while focusing on the four major areas of teaching; tactile, kinesthetic, visual, and auditory skills. The interactive learning games can be developed for any type of personal computer or video gaming system that utilizes an interactive controller such as a joystick, keyboard, dance or pressure pad, instrument simulator, and the like. The user will be asked a question and will select an answer based on the type of game being played. A question appears on the screen and the user has a preset time limit to correctly answer and react to the question in accordance with the type of game being played. The actual playing of the game is directly related to the user's actions, whether or not the user answers the question correctly. The goal is to keep the user engaged and playing the game at all times while learning the particular subject matter being presented, rather than worrying about having to repeat or review subject matter. A teacher, parent or other administrator can set the skill level, set the subject matter, set the question type and track or monitor each user's progress.

### CROSS-REFERENCE TO RELATED APPLICATION

This application claims the benefit of U.S. Provisional Application No. 61/065,068 filed Feb. 8, 2008.

### BACKGROUND OF THE INVENTION

1. Field of the Invention

The present invention is directed to a method and system of interactive learning designed to help a user improve their overall academic skill and automatic processing ability for a plurality of subject matters. In particular, the present invention utilizes methods of interactive teaching for use on a video gaming system, personal electronic device, and/or a personal computer. More particularly, the present invention allows a user to learn better in the classroom or at home, through the use of various interactive sports games designed specifically for any subject matter focusing on the four major areas of teaching, which are tactile, kinesthetic, visual, and auditory skills.

2. Brief Description of the Related Art

In the educational field and in most educational systems, there are often problems associated with traditional teaching methods and keeping students motivated to learn in the classroom and outside of class at home. The traditional teaching method used in most school systems comprises a teacher lecturing in front of a classroom filled with students. This traditional method is usually followed by a homework assignment which is given to the students to take home and finish.

It is often the case that these traditional methods fall short of meeting the needs of the student and make it very difficult for a teacher to monitor and track his or her student's progress. Moreover, traditional teaching methods also make it difficult for teachers to identify the specific areas or subject matter providing difficulty for that student. If a teacher cannot identify the specific areas or subject matter a student is having problems with, then that teacher can not provide the proper specific remedial work necessary to help the student overcome his or her weaknesses. In this day and age with the rapid growth of technology, computers, video games and online gaming, there are new and improved ways to target students for remedial learning and keep them motivated to learn through the use of interactive games.

There are, in the prior art, many educational learning programs, educational packages, educational computer training aids and educational interactive games which attempt to help teachers in the classroom and students at home. Most of these programs or services only reinforce what is wrong with the traditional classroom teaching methods, while others seek to put a new and improved spin on the same old traditional classroom teaching method. The results of these programs, while some are effective, still do not solve the problem of keeping students in this current digital age interested in learning the subject matter. Teachers often lack the necessary tools needed to truly engage their students in ways that are interesting to the student. Most students in this digital age relate to computer games and video games which allow them to interact with other students or friends in a session together at a physical location (i.e. home) or through interaction online via the internet.

In the prior art there are several educational video games which use an entertaining interactive interface to engage the user. These educational video games feature varying levels of difficulty in an interactive audio/video environment. Some of these educational video games take the form of a sports game, a shooting game or an interactive battle or 1^{st} person shooting game. The educational video games may even provide online connectivity.

US Patent Publication US2008/0070682A1 discloses a specific video gaming system and relates to systems and methods that are provided to enable young children (e.g. toddlers to pre-kindergarten aged children) and/or persons with disabilities to easily play, and effectively learn from, interactive, educational, and entertaining (hereinafter, “edutainment”) games. The edutainment game may be a series of instructions stored on a digital storage medium for use with a game system. The young child or person with a disability may play the game using a wireless, handheld controller that is easily graspable, maneuverable, and manipulatable, and the young child or person with a disability may play the game alone or with supervision by another person. The edutainment games may include one or more learning tools (or learning games), emphasizing skills such as, for example, color, shape, and/or sound recognition; puzzle-solving; navigation; number recognition, counting, and/or ordering; alphabet and reading/writing; etc. These skills may be emphasized individually or in various combinations.

US Patent Publication US2007/0021168 discloses a device, system and method of interactive quiz game. A method of operating an interactive quiz game may include, for example: sequentially presenting a stream of statements to a plurality of participating stations at pre-defined time intervals; receiving responses from participating stations to the presented stream of statements within a pre-defined response period following presentation of each statement; if a response received from a participating station is correct, incrementing a value of a score counter associated with said participating station; if a response received from a participating station is incorrect, terminating the participation of said station in the interactive quiz game; if the value of a score counter associated with a participating station reaches a pre-defined target value, determining that said station is a winner.

US Patent Publication US2007/0231780 describes another method for interactive learning. The method comprises displaying a first question related to a chosen category in a first round and instituting steps (a) and (b) where step (a) is providing a first set of answer choices corresponding to the first question, wherein the set of answer choices comprises at least one correct answer to the first question; and step (b) is receiving a selected answer choice. The method may include initiating a video game, for a predetermined period of playtime on the display, in response to a correctly selected answer choice. The method proceeds to a second round after the predetermined period of playtime has expired. If the selected response was incorrect, the method calls for a remedial lesson corresponding to the subject matter of the first incorrectly answered question.

Further, the method can include displaying a second question after the remedial lesson related to the category, receiving a second selected answer, and initiating the video game for the predetermined period of playtime on the display in response to the second selected answer being a correct answer; otherwise proceeding to another remedial lesson. Still further, the method may comprise generating a report based on a record of the questions and the corresponding chosen answers wherein the report is provided to an instructor.

As stated above, the prior art still falls short of solving the problem of keeping students in this current digital age interested in concurrently learning the subject matter taught in school. Students today relate to computer games and video games which allow them to interact with other students or friends in a session together at a physical location (i.e. home) or through interaction online via the internet.

In the prior art and more specifically in US Patent Publication US2007/0231780, the use of video game play, particularly sports type games, are employed as a method for interactive learning. The method for interactive learning requires the user to answer a question or set of questions for a given category, and after successfully or correctly answering the question or questions, is given reward points or is allowed to play a portion of a video game for a specific period of time (i.e. the game is unlocked).

After playing for a specified period of time which is pre-determined, the game locks and a new round of questioning begins. This patent application also provides a remedial session that attempts to retrain the user who has not successfully completed the round or has not answered the pre-set number of questions required to unlock the game. An instructor, administrator and/or parent can pre-set the limits of the interactive learning session and can monitor the progress of each user.

It is an object of the present invention to overcome the shortcomings of the prior art stated above. It is another object of the present invention to provide a truly interactive method of interactive learning where the user is interactively involved in the video game play. Such interactive video game play may comprise a sports game, a shooting game or an interactive battle or 1^{st} person shooting game. The user and video game play are combined and the interactive learning is part of the actual game play.

### DESCRIPTION OF THE INVENTION

The method and system of the present invention is designed to help a user improve their overall academic skill and automatic processing ability, while focusing on the four major areas of teaching; tactile, kinesthetic, visual, and auditory skills. The truly interactive learning games of the present invention are a great way to have fun and move around, while learning all at the same time. A typical embodiment of the present invention comprises a television or computer monitor (or any conventional graphical user interface or device for displaying graphics now known or hereinafter developed), and the interactive learning games can be developed for any type of personal computer, personal electronic device, video gaming system, or any device for interpreting and acting upon source code that utilizes an interactive controller such as a joystick, keyboard, dance or pressure pad, instrument simulator, and the like. The user will be asked a question and will select an answer based on the type of game being played. These games can be developed to accommodate any type of learning need, style and/or age.

Based on the forgoing method, a user must login to a personal computer or other similar data storage device and setup their personal profile for the video gaming system. Once logged in, the user selects a game to play. The question appears on the screen and the user has a preset time limit to correctly answer and react to the question based upon the type of game being played. The actual playing of the game is directly related to the user's actions whether or not the user answers the question correctly.

The method of interactive learning according to the present invention also features a review session if a user is having difficulty with a set of questions or specific subject matter. The goal is to keep the user engaged and playing the game at all times while learning the particular subject matter being presented rather than worrying about having to repeat or review subject matter. A teacher, parent, administrator, or even the user can set the skill level, set the subject matter, input new or related questions, set the question type and track or monitor each user's progress. These interactive games can be developed to accommodate any type of subject matter aligned with any state educational standards and state or federal assessments. Additionally, these interactive games can be set up as units or individual smaller games. The interactive learning games can be played in an educational setting, at home, via the internet or any combination thereof.

### BRIEF DESCRIPTION OF THE DRAWINGS

FIG. 1 provides a flow diagram that illustrates the overall process of actions that may occur within a method and system of interactive learning according to the present invention.

FIG. 2 provides a flow diagram of a method and system of interactive learning according to the present invention illustrating a baseball type game example.

FIG. 3 provides a perspective view of a user playing the interactive baseball type game in the embodiment of the present invention illustrated in FIG. 2.

FIG. 4 provides a perspective view of another user playing the interactive baseball type game in the embodiment of the present invention illustrated in FIG. 2.

FIG. 5 provides a chart that illustrates how a user's data is tracked and recorded according to the present invention.

FIG. 6 provides a chart that illustrates how a user's data is tracked and recorded according to the present invention.

FIG. 7 provides an illustration of system of interactive learning according to the present invention employing the use of a dance or pressure pad.

### DETAILED DESCRIPTION OF THE INVENTION

A method and system according to the present invention 10, comprises a principal user of the method and system, or group of users that create a user/group or profile. The teacher, parent or other administrator can control the user profile as well as specify limits and a plurality of predetermined game settings based on the individual user or group. Once a profile has been created and the system settings have been established, the user can select a game from a plurality of gaming choices (i.e. sports game, a shooting game, an interactive battle or 1^{st} person shooting game, or any interactive game employing such as a joystick, keyboard, dance or pressure pad, instrument simulator, and the like).

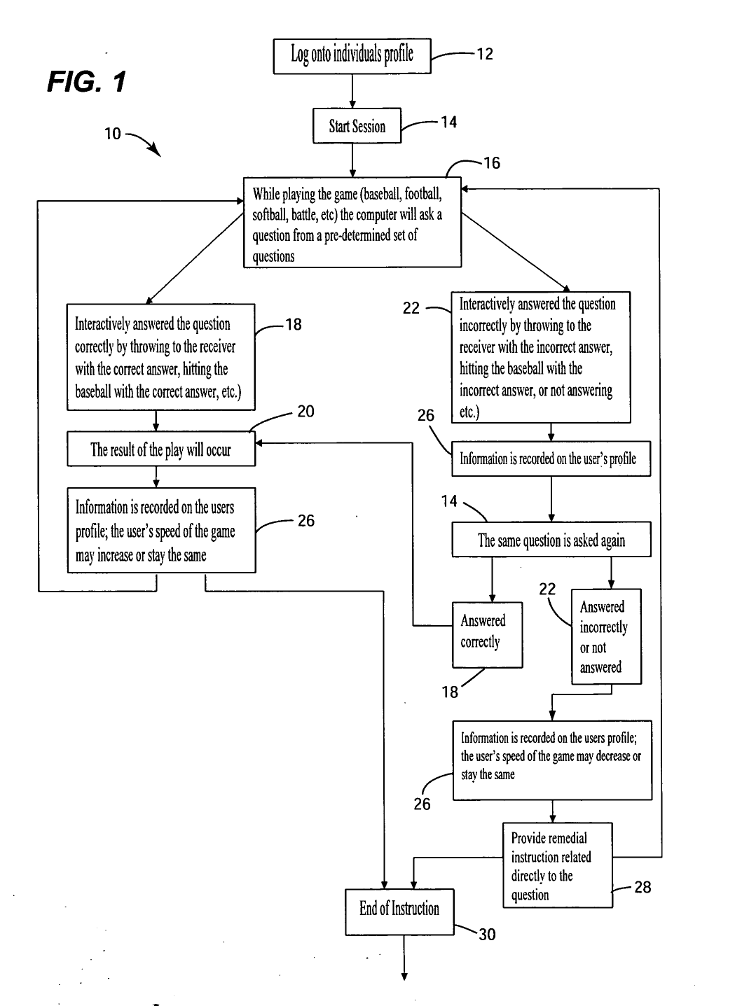

As shown in FIG. 1, the steps of the method for interactive learning comprises logging into a user profile 12 followed by starting a gaming session 14. To start the game, the computer will ask a question from a pre-determined set of questions 16. The user must correctly answer the question by interactively performing the correct action 18 according to the type of game being played. The result 20 of the game type being played will occur after the user correctly performs the action 18.

The user's information is then recorded 26 in the users profile. As the user progresses through the specific game, the speed of the questions may increase, decrease or stay the same depending on the settings applied to the user's profile.

If a question is answered incorrectly by the user performing the wrong action 22, that information is recorded 26 in the users profile and the question will be repeated 24. If the question is answered correctly 18, then the result 20 of the game type being played will occur. If the user does not answer the question correctly for the second time 22, this information is recorded 26 in the users profile and the user will be directed to a review tutorial 28 on the subject matter being taught. The user then reaches the end of the session 30 or continues play 16.

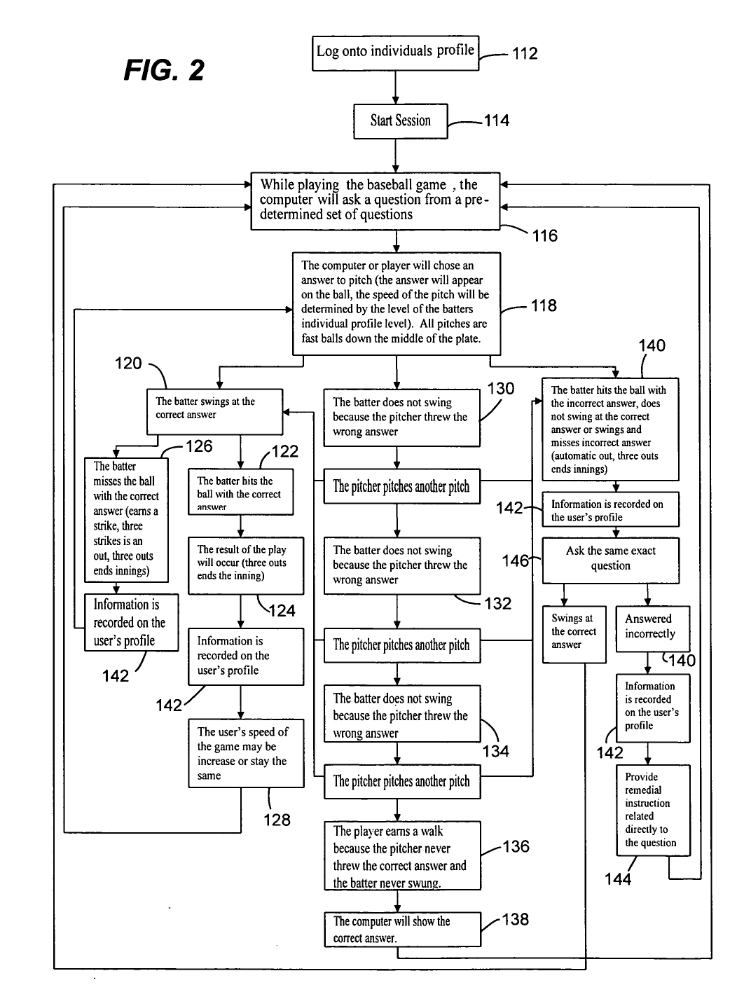

As shown in FIG. 2, in one embodiment of the present invention, a user logs into their profile 112 and starts a new session by selecting an interactive baseball type game 114. While playing the interactive baseball game, the computer will ask a question 116 from a pre-determined set of questions which depend on the subject matter assigned to the users profile. The pitcher will begin to pitch balls with correct and incorrect answers 118. The user must swing 120 at the ball which corresponds to the correct answer. If he swings 120 at the correct answer, he makes contact with the ball and the computer or the second player must react to the outcome of the hit 122. Normal baseball play occurs 124 and the outcome could be but is not limited to a strike, foul ball, ground ball, fly ball or home run. If the user fails to make contact with the ball after swinging at a correct answer, the user earns a strike. After 3 strikes, the user is out and after 3 outs the inning is over and user switches sides.

If the user selects the wrong answer 140 then he is called out and after 3 outs the inning is over and user switches sides. In between outs, the computer will ask the question again 116. The user can swing at the correct answer choice 120 or select the wrong answer choice 140.

If the user does not swing 130 at a wrong answer choice thrown by the pitcher 118, then a ball 132 is called. After 4 balls 132 are called the user earns a walk 136. The correct answer choice 138 will then be displayed.

The information is then recorded into the user's profile 142. As the user progresses through the game, the speed of the questions may increase, decrease or stay the same 128 depending on the settings applied to the user's profile. This is an option which can be pre-set in the controls or by a teacher, parent or other administrator. For example, if the speed of the game 128 is increased during an interactive baseball type game, the balls from the pitcher 118 which correspond to answer choices begin to come faster and faster and the user must make his choices by swinging 120 faster.

If a user is having difficulty or does not answer the pre-set number of questions correctly, then a remedial instruction session 144 related directly to the question or set of questions will begin. The goal of the present invention is to allow for smooth game play and interactive learning while not boring the user with tutorials and interruptions.

Once a teacher, parent or other administrator, logs into the system or game and checks on the progress of the user, they can also adjust the questions or can determine what questions the user was having difficulty with and then provide remedial instruction outside of the game itself.

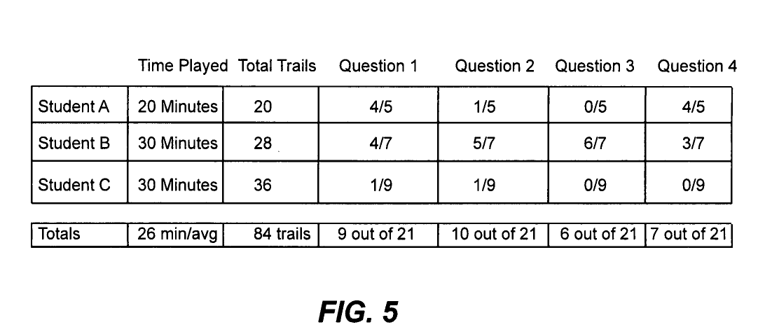

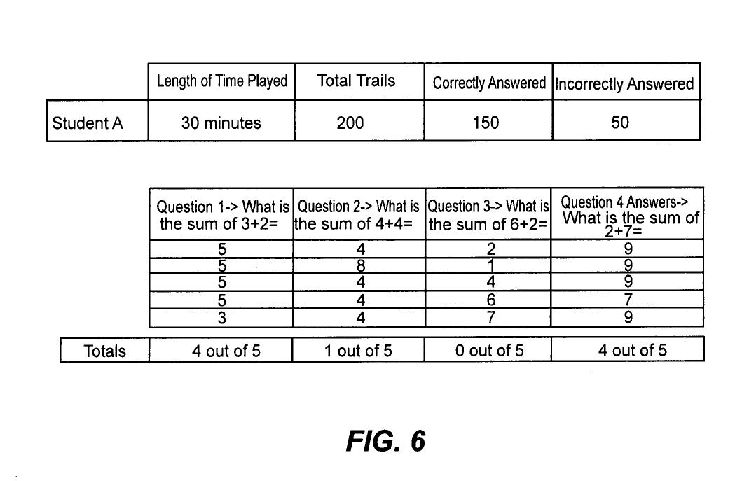

As shown is FIGS. 5 and 6, the user's data for each session is calculated and this information can be used to track the user's progress. The user can log back into the game and try again with the same questions or with a new set of questions from the same subject matter.

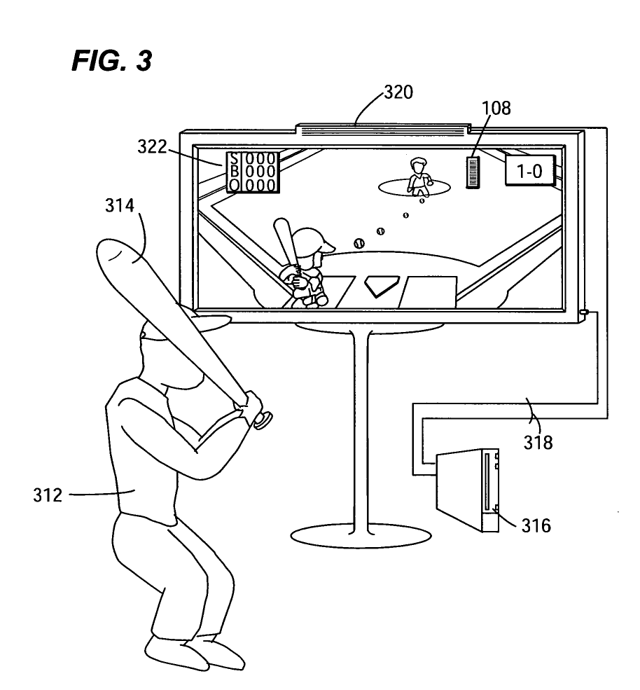

One embodiment of the baseball type interactive learning game is shown in FIG. 3. A user 312 holding a special wireless controller 314 is playing an interactive baseball type learning game. The game is displayed on a standard TV monitor 322, or any conventional device for displaying graphics now known or hereinafter developed, and utilizes a video gaming unit (VGU) 316 which utilizes standard input/output AV cables 318 to connect to the TV monitor 322. A transmitter 320 is connected to the VGU 316 for use with the special wireless controller 314. The display on the TV monitor represents a typical view on the interactive baseball game from the users 312 perspective. The user 312 would be in the batting position waiting for a question to be displayed visually or for an audible type question. Once the question is asked the pitcher would throw various answers to entice the user 312 to swing. The user 312 must swing at the correct answer using the special wireless controller 314 and the result of the play would occur.

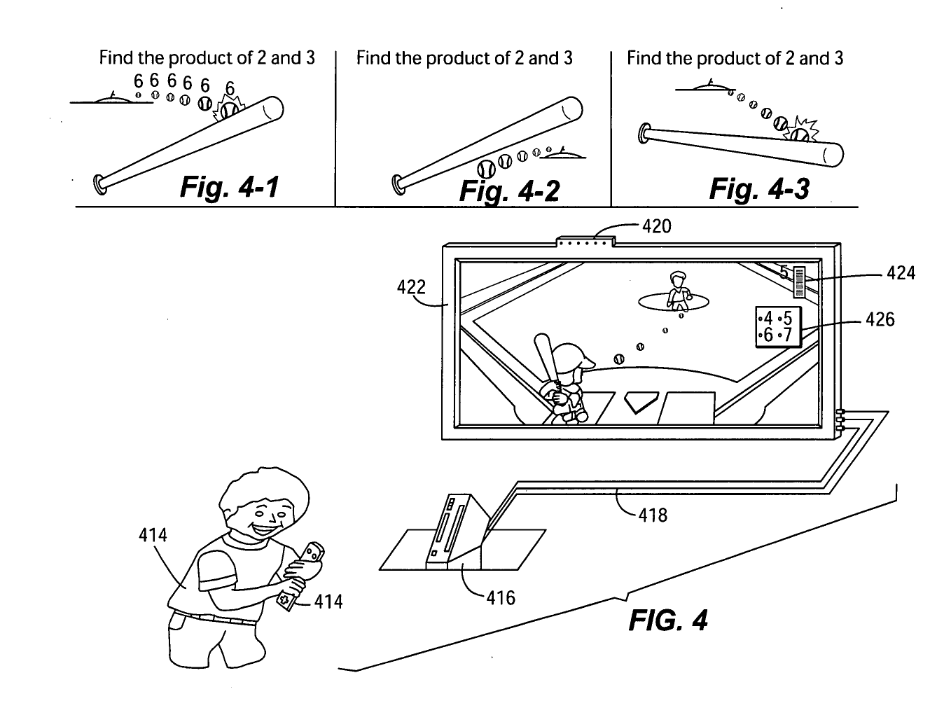

A more detailed embodiment of the baseball type interactive learning game is shown in FIG. 4. A user 412 is shown holding a wireless controller/remote 414 which sends signals through a transmitter 420 to the video gaming unit (VGU) 416. The VGU 416 utilizes standard input/output AV cables 418 to connect the VGU 416 to a standard TV monitor 422.

A means for asking the question in this interactive baseball type game is either audio or visually. A question is asked “Find the product of 2 and 3.” In FIG. 4-1, the user 412 swings at a correct answer choice and makes contact with the ball. The result of that play will occur. In FIG. 4-2, the user 412 swings at a correct answer choice and misses the ball. The result of play will occur as a strike. In FIG. 4-3, the user 412 swings at the wrong answer choice but still makes contact with the ball. The result of this play will occur as an out. A timer 424 is displayed on the TV monitor 422 screen which gives the user 412 a predetermined amount of time to answer the question. The timer 424 can be manually adjusted in the setting portion of the game or set to increase or decrease depending on the users 412 game performance. The answer and/or question display 426 also may or may not be displayed according the user's level of comprehension and skill.

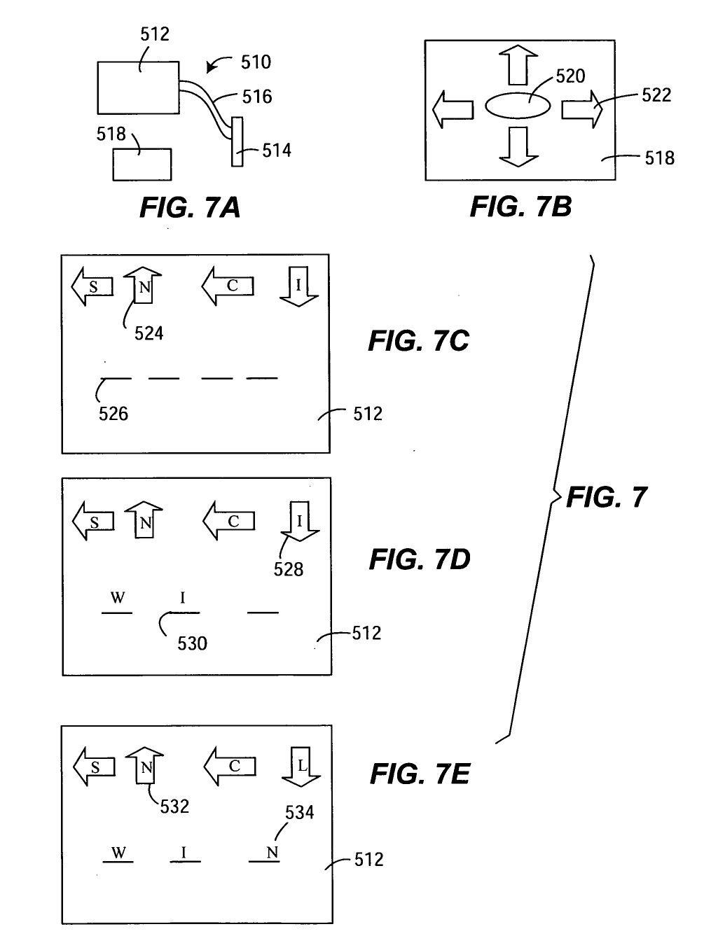

Another embodiment 510 of the present invention is shown in FIG. 7. As shown in FIG. 7A, a reading/spelling game is displayed on a standard TV monitor 512 and utilizes a video gaming unit (VGU) 514 which utilizes standard input/output AV cables 516 to connect to the TV monitor 512. Preferably, a transmitter is connected to the VGU 514 for use with a wireless dance pad or pressure pad 518; however, pressure pad 518 may be connected to VGU 514 via conventional wire connections.

The interactive learning game 510 comprises a reading/spelling game in which a computer generated voice will say spell the word “win.” FIG. 7B illustrates one embodiment of a wireless interactive pressure pad 518 that is connected to a VGU 514. FIG. 7C represents the TV monitor 512 displaying a series of letters encapsulated within arrows. The user will stand in the middle 520 of pressure pad 518 and depress an arrow 522 that represents the correct letter 524 on the TV monitor 512. For example, the user will depress the up arrow 524 with their foot to put a “W” in the first slot 526. If the wrong arrow is depressed, the user gets another chance. The data is recorded.

Continuing with FIG. 7D, the “W” can now be replaced with any letter. In this illustration, the “W” is replaced with an “N”. The user will depress the down arrow 528 with their foot to put an “I” in the second slot 530. If the wrong arrow is depressed, the player gets another chance. The data is recorded.

Continuing with FIG. 7E, the “I” can now be replaced with any letter. In this illustration, the “I” is replaced with an “L”. The user depresses the up arrow 532 with their foot to put an “N” in the third and final slot 534. If the wrong arrow is depressed, the player gets another chance. The data is recorded.

The embodiment shown in FIG. 7 represents one subject that users can “learn” through dancing. As with all of the embodiments presented herein and considered within the scope of the invention, any lesson can be taught through this style of teaching.

Although the invention has been described in considerable detail with respect to particular embodiments of the Applicant's method and system of interactive learning, it will be apparent that the invention is capable of numerous modifications and variations, apparent to those skilled in the art, without departing from the spirit and scope of the invention.

1. A system for interactive learning comprising:
a) a device for displaying graphics;
b) a device for interpreting and acting upon a source code;
c) a device for providing interactive control over the source code based upon a user's input; and
d) a device for recording and tracking the user's responses.

2. The system for interactive learning of claim 1 wherein:
a) the device for displaying graphics comprises one selected from the group consisting of a computer monitor, a television, a graphical user interface, and a personal electronic device;
b) the device for interpreting and acting upon a source code comprises one selected from the group consisting of a computer, a video gaming system, and a personal electronic device;
c) the device for providing interactive control over the source code based upon a user's input comprises one selected from the group consisting of a joystick, a keyboard, a pressure pad, and an instrument simulator; and
d) the device for recording and tracking the user's responses comprises one selected from the group consisting of a computer, a video gaming system, and a personal electronic device.

3. The system for interactive learning of claim 2 wherein the user's input is required within a specified time period.

4. The system for interactive learning of claim 3 wherein the source code provides for the display of subject matter learning material on the device for displaying graphics.

5. The system for interactive learning of claim 4 wherein the source code provides for a series of graphical user interface displays dependent upon the user's response to the subject matter learning material currently displayed on the device for displaying graphics.

6. The system for interactive learning of claim 5 wherein the series of graphical user interface displays comprises playing a baseball game wherein the user's responses to the subject matter learning material currently displayed prompts the source code to take a specified action.

7. The system for interactive learning of claim 5 wherein the series of graphical user interface displays comprises playing a football game wherein the user's responses to the subject matter learning material currently displayed prompts the source code to take a specified action.

8. The system for interactive learning of claim 5 wherein the series of graphical user interface displays comprises playing a battle game wherein the user's responses to the subject matter learning material currently displayed prompts the source code to take a specified action.

9. The system for interactive learning of claim 5 wherein the series of graphical user interface displays comprises playing a dance game wherein the user's responses to the subject matter learning material currently displayed prompts the source code to take a specified action.

10. A method for interactive learning comprising:
a) displaying graphics to a user on a graphical user interface;
b) interpreting and acting upon source code;
c) providing interactive control over the source code based upon the user's input; and
d) recording and tracking the user's responses.

11. The method for interactive learning of claim 10 wherein the user's input is required within a specified time period.

12. The method for interactive learning of claim 11 wherein the source code provides for the display of subject matter learning material on the graphical user interface.

13. The method for interactive learning of claim 12 wherein the source code provides for a series of graphical user interface displays dependent upon the user's response to the subject matter learning material currently displayed on the graphical user interface.

14. The method for interactive learning of claim 13 wherein the series of graphical user interface displays comprises playing a baseball game wherein the user's responses to the subject matter learning material currently displayed prompts the source code to take a specified action.

15. The method for interactive learning of claim 13 wherein the series of graphical user interface displays comprises playing a football game wherein the user's responses to the subject matter learning material currently displayed prompts the source code to take a specified action.

16. The method for interactive learning of claim 13 wherein the series of graphical user interface displays comprises playing a battle game wherein the user's responses to the subject matter learning material currently displayed prompts the source code to take a specified action.

17. The method for interactive learning of claim 13 wherein the series of graphical user interface displays comprises playing a dance game wherein the user's responses to the subject matter learning material currently displayed prompts the source code to take a specified action.

18. A method for interactive learning comprising:
a) a means for displaying graphics to a user;
b) a means for interpreting and acting upon source code wherein the source code provides for a series of graphical user interface displays dependent upon the user's response to subject matter learning material currently displayed on the means for displaying graphics;
c) a means for providing interactive control over the source code based upon the user's input wherein the user's responses to the subject matter learning material currently displayed prompts the source code to take a specified action; and
d) a means for recording and tracking the user's progress in learning subject matter learning material currently displayed.

19. The method for interactive learning of claim 18 wherein the means for providing steps (a) through (e) comprises one selected from the group consisting of a computer, a video gaming system, and a personal electronic device.

20. The method for interactive learning of claim 19 wherein the series of graphical user interface displays dependent upon the user's response to subject matter learning material currently displayed on the means for displaying graphics comprises a video game.
